(19) United States
(12) Patent Application Publication
(10) Pub. No.: US 2021/0384865 A1
(43) Pub. Date: Dec. 9, 2021

(54) METHOD AND SOLAR-BASED SYSTEM FOR SIMULTANEOUS ELECTRICITY AND FRESH WATER GENERATION

(71) Applicant: KING ABDULLAH UNIVERSITY OF SCIENCE AND TECHNOLOGY, Thuwal (SA)

(72) Inventors: Peng WANG, Thuwal (SA); Wenbin WANG, Thuwal (SA); Yifeng SHI, Thuwal (SA)

(21) Appl. No.: 17/287,302

(22) PCT Filed: Oct. 8, 2019
(86) PCT No.: PCT/IB2019/058562

§ 371 Date: Apr. 21, 2021

Related U.S. Application Data
(60) Provisional application No. 62/883,878, filed on Aug. 7, 2019.
(60) Provisional application No. 62/767,647, filed on Nov. 15, 2018.

(51) Int. Cl. H02S 40/44; B01D 61/36; B01D 63/08; C02F 1/44

(52) U.S. Cl. CPC H02S 40/44; B01D 61/364; B01D 61/366; B01D 61/368; B01D 63/082; C02F 2201/009; C02F 1/447; B01D 2313/143; B01D 2313/146; B01D 2313/36; B01D 63/087

(57) ABSTRACT

An integrated solar PV panel-membrane distillation system includes a solar photovoltaic panel having a front face for receiving solar energy and a back face, opposite to the front face and a membrane distillation device attached directly to the back face of the solar photovoltaic panel. The solar photovoltaic panel is configured to simultaneously generate electrical energy and transfer heat to the back membrane distillation device for generating fresh water from contaminated water.

### CROSS-REFERENCE TO RELATED APPLICATIONS

This application claims priority to U.S. Provisional Patent Application No. 62/767,647, filed on Nov. 15, 2018, entitled “DEVICE FOR ELECTRICITY GENERATION AND WATER DESALINATION BY SOLAR LIGHT,” and U.S. Provisional Patent Application No. 62/883,878, filed on Aug. 7, 2019, entitled “METHOD AND SOLAR-BASED SYSTEM FOR SIMULTANEOUS ELECTRICITY AND FRESH WATER GENERATION,” the disclosures of which are incorporated herein by reference in their entirety.

### BACKGROUND

### Technical Field

Embodiments of the subject matter disclosed herein generally relate to a method and system for generating electricity and clean water production using solar energy, and more particularly, to a system that uses a solar panel as a photothermal component for simultaneously generating clean water and electricity.

### Discussion of the Background

Water and energy are inextricably linked and the intimate water-energy nexus is being felt globally, as water security is becoming a threat to energy security and vice versa. In the United States and Western Europe, about 50% of the water withdrawals are for energy production. On the other hand, clean water production, especially seawater desalination, consumes a large amount of electricity. For example, in the Arab countries, more than 15% of the total national electricity is consumed by the fresh water production industry. It has been reported that 1-10% of the clean water produced in the electricity-driven seawater desalination process is fed back to the power plant to generate the electricity consumed during the desalination process. The negative ramifications of the water-energy nexus have been felt especially in the arid and semi-arid regions.

The current share of nonrenewable fossil fuels in the global energy mix is still larger than 82% and the burning of fossil fuels leads to massive CO₂ emissions, which is regarded as a major threat to the global sustainability. Sustained efforts are being made to develop and implement renewable energy sources, among which the solar energy has shown its potential to meet the world's future energy demands given its abundance and free availability. Large amounts of photovoltaics (PV) panels (>400 GW) have been installed all over the world to generate electricity from solar energy with minimal CO₂ emission and water consumption.

In this regard note that for each MWh of generated electricity, the PV technology consumes only 2 gallons of water while the conventional thermal power plants, which use coal or nuclear fuel as the main source of energy, consume 692 and 572 gallons of water, respectively. However, solar irradiation has a quite low energy intensity, generally in the range of 4-8 kW·m⁻² per day for the most parts of the world. Moreover, only about 10-20% of the energy from sunlight can be converted to electricity by the state-of-the-art commercial PV panels. As a result of this low efficiency, for a medium-sized solar power plant of 400 MW, it would need to collect sunlight from at least 2 million m² land area. Besides the cost of the solar panels and land procurement, the mounting system supporting the panels on such a large area adds further capital cost to the solar power plant. Thus, for these reasons, the solar energy generation is still facing cost barriers.

Solar distillation has recently attracted considerable attention and has demonstrated promising potential in various processes aimed at seawater desalination, potable water production from quality-impaired water sources, wastewater volume reduction, metal extraction and recycling, sterilization, etc. However, similar to the solar-to-electricity generation process discussed above, the inherent low-energy intensity of the solar irradiation leads to a small fresh water production rate in conventional solar distillation facilities, for example, 0.5-4.0 kg·m⁻² for a whole day, which is equivalent to a water production rate of 0.3-0.7 kg·m⁻²·h⁻¹ under the standard of one Sun illumination condition (1 kW·m⁻²).

This low productivity requires a large land area and the installation of a mounting system to support the distillation setup, which constrains its economic vitality and benefit, similar to the case of the PV-based power plants discussed above. Recently, solar-driven multi-stage membrane distillation (MSMD) devices have been reported with a much higher clean water productivity, for example, 3 kg·m⁻²·h⁻¹ in a 10-stage device under one Sun illumination, by recycling the latent heat released during the vapor condensation in each stage as the heat source for the next stage.

The concept of simultaneous production of clean water and electricity from solar energy has been recently investigated by several groups [1-3]. However, in these attempts, the solar distillation was utilized for clean water production and some side effects of the solar distillation were utilized for electricity generation, which led to low solar-to-electricity energy efficiency (<1.3%). The low-electricity generation efficiency of these strategies makes it uneconomical to apply them in commercial power plants.

Thus, there is a need for a new system that simultaneously produces fresh water and generates electricity with a high-efficiency, based on solar power, so that large-scale applications are economically viable.

### BRIEF SUMMARY OF THE INVENTION

According to an embodiment, there is an integrated solar PV panel-membrane distillation system that includes a solar photovoltaic panel having a front face for receiving solar energy and a back face, opposite to the front face, and a membrane distillation device attached directly to the back face of the solar photovoltaic panel. The solar photovoltaic panel is configured to simultaneously generate electrical energy and transfer heat to the back membrane distillation device for generating fresh water from contaminated water.

According to another embodiment, there is a method for simultaneously generating electrical energy and clean water. The method includes generating electrical energy from solar energy with a solar photovoltaic panel having a front face and a back face, which is opposite to the front face, transferring heat from the solar photovoltaic panel to a multi-stage membrane distillation device, which is attached directly to the back face of the solar photovoltaic panel, and generating fresh water from contaminated water with the multi-stage membrane distillation device, based on the heat from the solar photovoltaic panel.

According to still another embodiment, there is an integrated solar PV panel-membrane distillation system that includes a solar photovoltaic panel having a front face for receiving solar energy and a back face, opposite to the front face, a membrane distillation device attached directly to the back face of the solar photovoltaic panel, and an evaporative crystallizer layer attached to the membrane distillation device, the evaporative crystallizer layer being configured to cool down a bottom layer of the membrane distillation device. The solar photovoltaic panel is configured to simultaneously generate electrical energy and transfer heat to the back membrane distillation device for generating fresh water from contaminated water.

### BRIEF DESCRIPTION OF THE DRAWINGS

For a more complete understanding of the present invention, reference is now made to the following descriptions taken in conjunction with the accompanying drawings, in which:

FIG. 1 is a schematic diagram of an integrated solar PV panel-membrane distillation system in which a solar panel is directly attached to a membrane distillation device;

FIG. 2 is an overview of the integrated solar PV panel-membrane distillation system in which a solar panel is directly attached to a membrane distillation device;

FIG. 3 is a schematic diagram of another integrated solar PV panel-membrane distillation system in which a solar panel is directly attached to a membrane distillation device;

FIG. 4 is a schematic diagram of still another integrated solar PV panel-membrane distillation system in which a solar panel is directly attached to a membrane distillation device;

FIG. 5 is a schematic diagram of yet another integrated solar PV panel-membrane distillation system in which a solar panel is directly attached to a membrane distillation device;

FIG. 6A is an overview of the integrated solar PV panel-membrane distillation system in which a solar panel is directly attached to a membrane distillation device and FIG. 6B illustrates a modification of the embodiment of FIG. 6A, in which an evaporative crystallizer layer is added to a bottom of integrated solar PV panel-membrane distillation system;

FIGS. 7A to 8C illustrate various characteristics of the integrated solar PV panel-membrane distillation systems shown in the previous figures;

FIG. 9 illustrates the clean water production rate of the integrated solar PV panel-membrane distillation system over plural cycles;

FIG. 10 illustrates the amount of ions in the source water and the clean water generated with the integrated solar PV panel-membrane distillation system; and

FIG. 11 is flowchart of a method for simultaneously generating clean water and electricity with the integrated solar PV panel-membrane distillation system.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a system that uses a PV panel and a membrane-based device to simultaneously generate electrical power and fresh water. However, the embodiments to be discussed next are not limited to such a system, but they may be applied to a system that uses another type of fresh water generation device.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, a system that simultaneously produces fresh water and electricity is an integrated solar PV panel-membrane distillation (PV-MD) system in which the PV panel is employed as both (1) the photovoltaic component for generating electricity and (2) as the photothermal component for clean water production. In a typical solar cell, 80-90% of the absorbed solar energy is undesirably converted to heat, and thereafter passively and wastefully dumped into the ambient air. In this embodiment, different from the existing devices, a MSMD device is directly integrated on the backside of the PV panel to directly utilize its waste heat as a heat source to drive the water distillation. Under one Sun illumination, the water production rate of the novel PV-MD system was measured to be 1.79 kg·m⁻²·h⁻¹ for a 3-stage MSMD device, which is three times higher than that of the conventional solar stills. At the same time, the PV panel generates electricity with an energy efficiency higher than 11%, which is the same as that recorded for the same PV panel without the back MSMD device. The benefit of the integration of the PV panel and the water distillation device is the highly efficient co-generation of clean water and electricity in a single system at the same time, having the same land footprint, which directly reduces the land area requirement for running such systems and also reducing the cost associated with the mounting system, as compared to two physically separate systems (PV and solar distillation systems). In one application, by using commercial solar cells for such a system makes the PV-MD system more appropriate for practical applications. This integrated system provides a solution for transforming a solar-based electricity generation plant, from otherwise a water consumer, to a fresh water producer.

One or more of the benefits of this new integrated PV-MD system are: (1) the electricity generation efficiency is much higher than those reported clean water-electricity cogeneration devices in literature; (2) the clean water production rate is much higher than those systems reported in literature; (3) in some cases, because the heat generated from the solar panel is used for water distillation, the temperature of the solar panel is reduced and the energy efficiency of the solar panel is accordingly increased; (4) because both the electricity and clean water can be efficiently generated with the same device and with the same mounting system, this novel system reduces the cost of land as well as the cost of the mounting system for such a system; and (5) because the water distillation system is physically and thermally sealed, the system can operate even in constant windy conditions. This novel system is now discussed in more detail with regard to the figures.

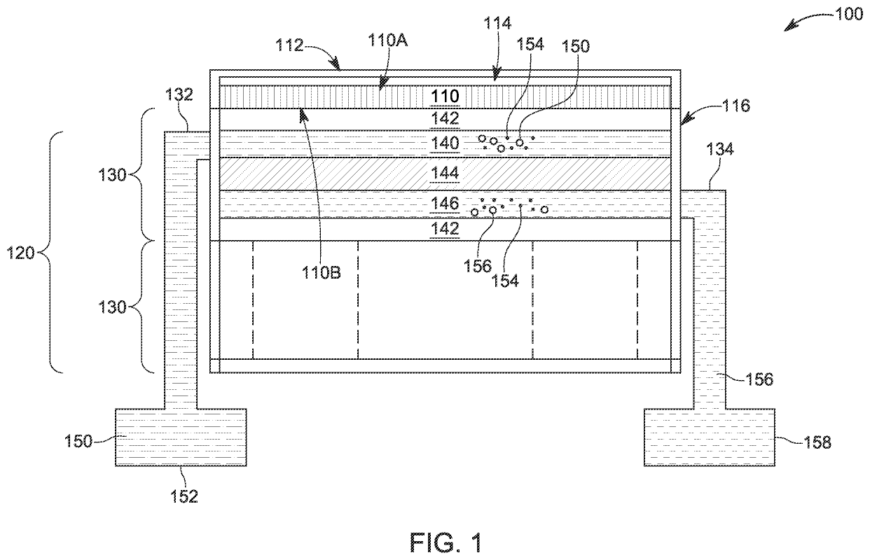

According to an embodiment illustrated in FIG. 1, the integrated solar PV panel-membrane distillation system 100 (PV-MD system herein) includes a solar PV panel 110 and a multi-stage membrane distillation device 120 formed in direct contact to each other. The PV panel 110 has a front face 110A that receives solar energy from the sun and a back face 1108, which is opposite to the front face 110A. In one application, the multi-stage membrane distillation device 120 (called herein the membrane distillation device) is directly attached to the back face 1108 of the solar PV panel 110 so that there is no space between the two elements. In still another application, the membrane distillation device 120 is directly connected to the back of the solar PV panel 110. The membrane distillation device 120 may include one or more single-stage membrane distillation elements 130, mechanically and thermally connected to each other, as illustrated in the figure. If plural single-stage membrane distillation elements 130 are mechanically and thermally attached to each other as shown in FIG. 1, then the multi-stage membrane distillation device 120 is formed.

To increase the efficiency of the system 100, in one application, a transparent cover 112 may be attached to the top of the solar PV panel 110 so that a chamber 114 is formed between the solar PV panel 110 and the transparent cover 112. In one application, vacuum is generated in the chamber 114 to eliminate the conduction heat loss. The transparent cover 112 may be made of a material that possesses a high-transmittance and low-thermal conductivity, such as glass, polyethylene terephthalate, Polycarbonate, polymethyl methacrylate and/or polyvinyl chloride.

Another optional feature of the system 100, for reducing the heat loss of the system to the environment, is a thermal insulator 116 that can be placed around the whole or only a part of the system 100. The thermal insulator 116 may include a low-thermal conductivity material such as glass fibers, silica gel, asbestos, inorganic porous insulation materials, polyurethane foam and/or polystyrene foam.

The system further includes an input 132 and an output 134 for each single-stage membrane distillation device 130. The input 132 provides contaminated water (for example, salt water) to a corresponding single-stage membrane distillation device 130, while the output 134 supplies the clean water to the outside of the system. The contaminated water can include not only seawater, by also lake water, river water, groundwater, industrial wastewater, brine, brackish water, etc. These source waters can be of impaired quality and can be contaminated with heavy metals, organics, radioactive materials, pesticides, or any other chemicals with health and environmental concerns.

The input 132 is fluidly connected to a water evaporation layer 140 for supplying the contaminated water for evaporation. The water evaporation layer 140 is, in this embodiment, located in direct contact with a heat conduction layer 142. The heat conduction layer 142 is in direct contact with the solar PV panel 110 and is configured to thermally transfer the heat from the back of the solar PV panel 110 to the water evaporation layer 140.

The solar PV panel 110 can be any kind of commercial or laboratory solar cell (such as amorphous Silicon solar cell, polycrystalline silica solar cell, monocrystalline solar cell, cadmium telluride solar cell, copper indium gallium selenide solar cells, dye-sensitized solar cell, gallium arsenide germanium solar cell, thin film solar cell, etc.). When a transparent solar cell is used, a black material can be placed under the solar cell to enhance the absorption of the sunlight. The heat conduction layer 142 could be made of a material that possess good thermal conductivity, such as, for example, copper (401 W/mK), zinc (116 W/mK), aluminum (237 W/mK), brass (109 W/mK), bronze (110 W/mK), graphite (168 W/mK), Ag (429 W/mK), silicon carbide (360-490 W/mK), iron (73 W/mK), stainless Steel (12-45 W/mK), or tin (62-68 W/mK). Other materials may be used. The water evaporation layer 140 may include a hydrophilic material that should possess hydrophilicity and a porous structures. An example of such a material may be non-woven fabrics, silica fibers, glass fibers, etc.

A hydrophobic layer 144 is placed below the water evaporation layer 140, as shown in the figure. The hydrophobic layer 144 includes a material that is hydrophobic and porous so that liquid water 150 from the water evaporation layer 140 cannot pass it. However, the hydrophobic layer 144 is configured to allow water vapor 154 to pass through. In one application, to increase the temperature gradient, the hydrophobic layer should also possess a low-thermal conductivity, or it can be composed of two or more kinds of materials, some of which possess low-thermal conductivity, such as polystyrene membrane, polyvinylidene fluoride, poly tetra fluoroethylene, etc.

A condensation layer 146 is placed below the hydrophobic layer 144 and is configured to condensate the water vapor 154 that passes through the hydrophobic layer 144, to form the fresh water 156. The condensation layer 146 may include a material that possess hydrophilicity and a porous structures, such as non-woven fabrics, silica fiber, glass fiber, etc.

The next single-stage membrane distillation device 130 has a similar structure, and for simplicity, only the heat conduction layer 142 of this second device 130 is shown in FIG. 1. However, many other single-stage membrane distillation devices 130 may be added to the system 100.

Note that the configuration shown in FIG. 1 has an input 132 for each device 130, but the water evaporation layer 140 connected to this input does not have an output. This means that the water entering the water evaporation layer 140 cannot exit the device 130, and for this reason, this configuration is called a dead-end configuration. The water 150 entering the water evaporation layer 140 can only evaporate and the water vapor 154 can then escape the water evaporation layer 140, through the hydrophobic layer 144. The same configuration is implemented in this embodiment for the condensation layer 146, i.e., the only source of water for this layer is from the water vapors 154 that pass the hydrophobic layer 144. Each condensation layer 146 has a single output 134, that collects the fresh water 156.

The system 100 works as now discussed. The source or contaminated water 150 can be adsorbed into the water evaporation layer 140, by capillary and transpiration effect, from a water source 152, or driven by the gravity or a pump. The water source 152 can be a container or a natural water reservoir. The heat from the solar PV panel 110 is transferred through the heat conduction layer 142 to the water evaporation layer 140. The contaminated water 150 from the water evaporation layer 140 evaporates due to the heat, leaving behind any solid contaminant that is present in the contaminated water. The condensation layer 146, which is a hydrophilic porous membrane, is insulated from the water evaporation layer 140 by the hydrophobic layer 144, which ensures that the high-salt or contaminant water 150 does not enter the condensation layer 146.

The water vapor 154 formed in the water evaporation layer 140 is forced to flow downward and gets condensed as condensed clean water 156 in the condensation layer 146. The condensed water 156 is then transported through the output 134 to a collector 158, by the gravity. The latent heat of the vapor 154, which is released during the condensation process, is used by the next single-stage membrane distillation device 130 as the heat source. The entire process is then repeated for each single-stage membrane distillation device 130.

As discussed above, the entire system 100 may be sealed by the thermal insulation material 116 to prevent vapor and heat loss. A larger temperature gradient between the water evaporation layer and the corresponding condensation layer will lead to a higher clean water production rate.

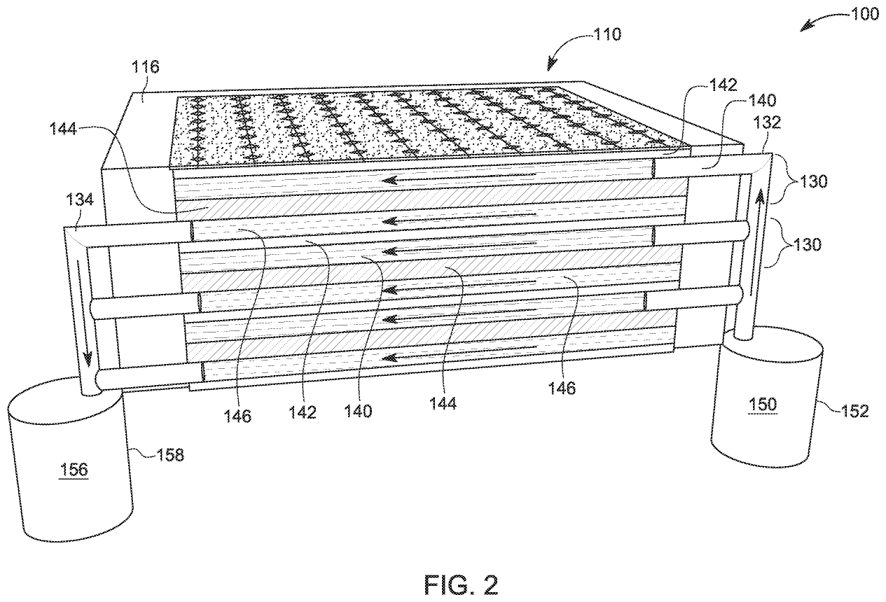

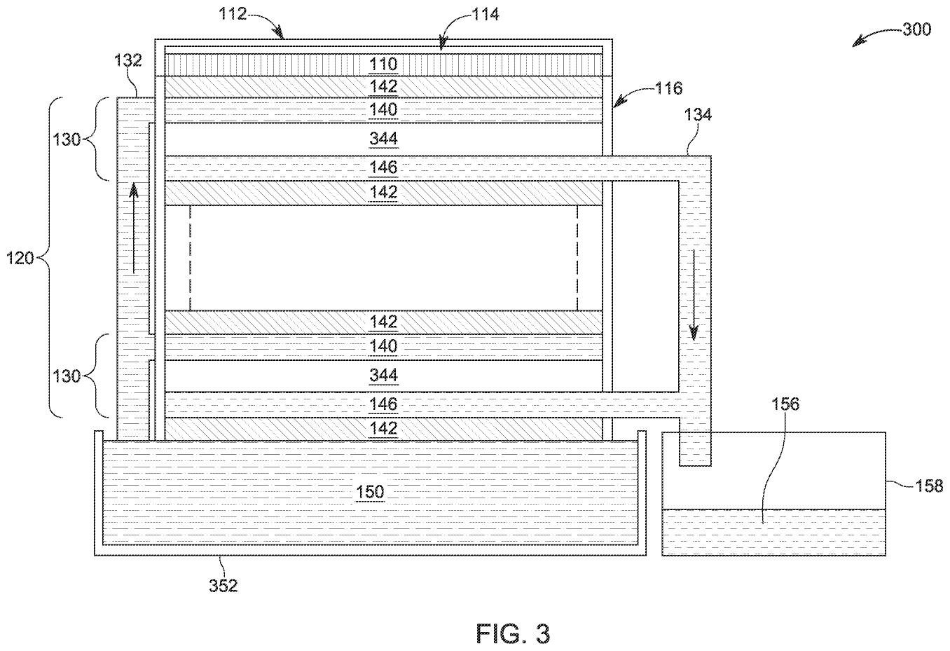

The system 100 discussed with regard to FIG. 1 integrates the solar PV panel 110 with the membrane distillation device 120 as a unitary mechanism. This means, that the solar PV panel 110 is directly attached to the membrane distillation device 120 and when installed, for example, on a support element, they are implemented as a single, unitary, element and they use a single support mechanism. The membrane distillation device 120 may be attached to the back of the PV panel in various ways, for example, welding, gluing, screws, etc. The integrated system 100 does not use pipes or other heat transfer means for achieving fluid or heat exchange between the solar PV panel 110 and the membrane distillation device 120. The heat exchange between the solar PV panel 110 and the membrane distillation device 120 is achieved by direct contact between these two elements. In this regard, FIG. 2 shows a perspective view of the integrated solar PV panel-membrane distillation system 100 that shows plural membrane distillation devices 130 attached to the back of the solar PV panel 110 and configured in the dead-end mode.

Another embodiment of an integrated solar PV panel-membrane distillation system 300 is shown in FIG. 3. System 300 is similar to system 100 except for the following modifications. The hydrophobic layer 144 is replaced with an air gap 344. The heat transfer between the heat conduction layers can be reduced by the use of the air gap 344 due to the low-thermal conductivity of the air. In addition, in this embodiment, the multi-stage membrane distillation device 120 is placed directly above a water source 352.

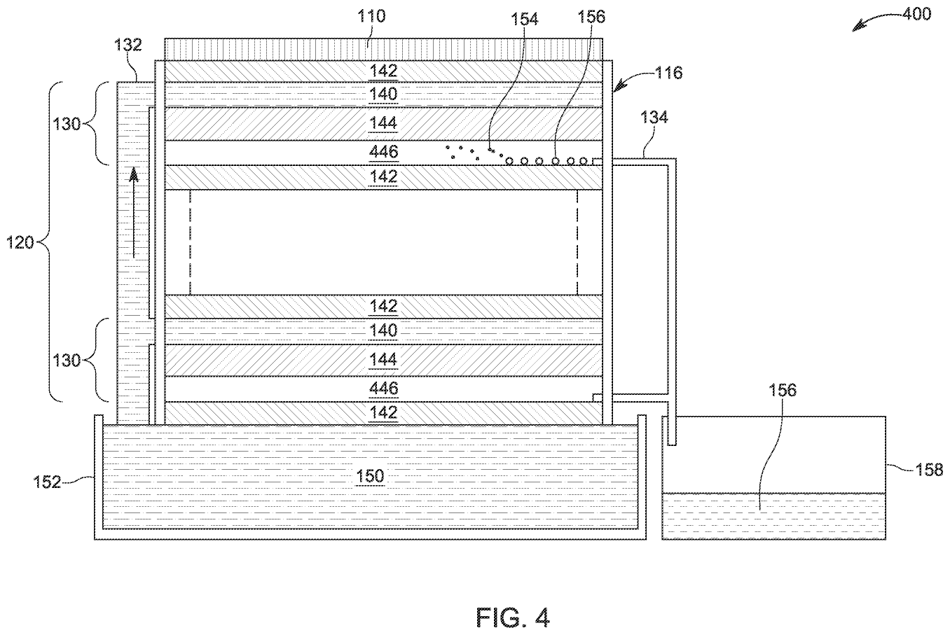

Another embodiment of an integrated solar PV panel-membrane distillation system 400 is shown in FIG. 4. System 400 is similar to system 100 except for the following modifications. The condensation layer 146, which includes a hydrophilic membrane, is replaced by a condensation layer 446 that it is empty, i.e., has no membrane inside. For this case, the water vapor 154 gets condensed on the surface of the heat conduction layer 142, and the formed water 156 will then roll out of the outlet 134 into the collection vessel 158. In addition, in this embodiment, the multi-stage membrane distillation device 120 is placed directly above the water source 152. In this regard, the membrane distillation device 120 may be configured to float on the water source 152 or it may be mechanically attached to the source. Note that the cover 112 is omitted in these figures for simplicity. However, the cover 112 may be added as desired.

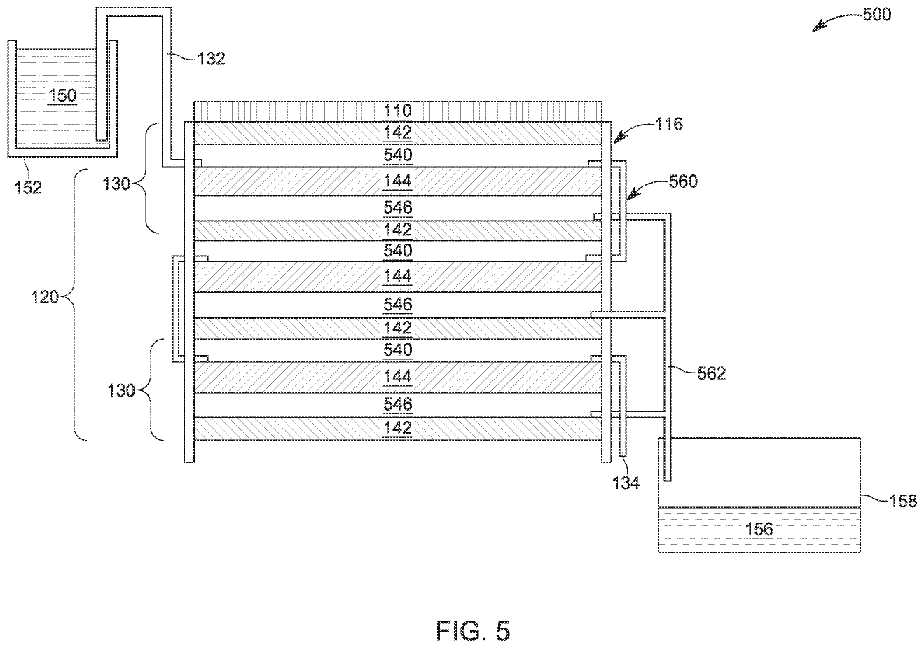

Another embodiment of an integrated solar PV panel-membrane distillation system 500 is shown in FIG. 5. System 500 is similar to system 100 except for the following modifications. The water evaporation layer 540 does not include a hydrophilic membrane. Instead, an air gap is present inside the water evaporation layer 540. However, in one application, a hydrophilic membrane may be placed inside the water evaporation layer 540. For this implementation with no hydrophilic membrane, the water source 152 is placed higher than the system top most single-stage membrane distillation device 130, so that the water 150 can be transported, for example, by the siphon effect, to the device 130. The water evaporation process in the water evaporation layer 540 may result in the crystallization of the salt in this layer.

To be able to remove the crystalized salt, in this embodiment, each water evaporation layer 540 is fluidly connected through a corresponding connecting pipe 560 to a next water evaporation layer (i.e., the water evaporation layers are connected in series) and the last water evaporation layer 540 has an output 134, as shown in FIG. 5. In this way, a cross-flow mode can be achieved instead of the dead-end mode, i.e., the contaminated water enters the system at the input 132 and leaves the system at output 134. Further, this design can simplify the cleaning of the system because the system can be cleaned by salt water with a low-salt concentration at night, when the salt water 150 with the low concentration is supplied to the source water container 152. The salt water with the low-concentration will flow through each evaporation layer 540, dissolve the crystalized salt, and carry it out at the output 134. This is not possible during the day because the heat generated by the solar PV panel 110 would evaporate the water.

Further, the system 500 may have the condensation layer 546 formed with no hydrophilic membrane, but rather with an air gap, similar to the system 400. However, in one application, a hydrophilic membrane may be placed inside the condensation layer 546. In this specific embodiment, the condensation layers 546 are also fluidly connected to each other (in parallel) with corresponding pipes 562 so that the clean water 156 formed in each of them collectively arrives at the container 158.

While this embodiment shows the water source container 152 placed higher than the top most single-stage membrane distillation device 130, one skilled in the art would understand that instead of placing the water source container at that position, it can be placed lower than the most single-stage membrane distillation device 130, and another means for supplying the contaminated water 150 to the system may be used, for example, a pump.

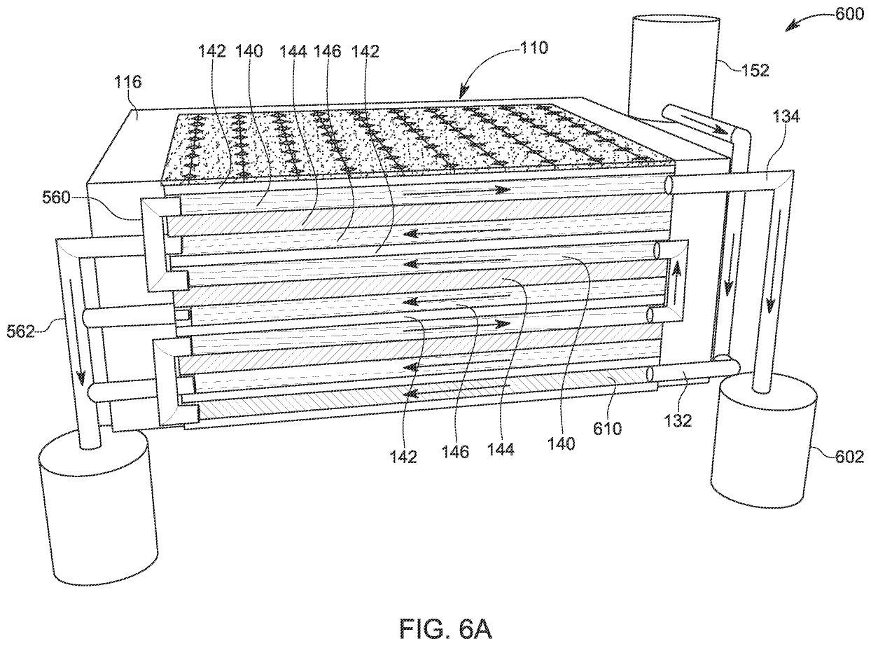

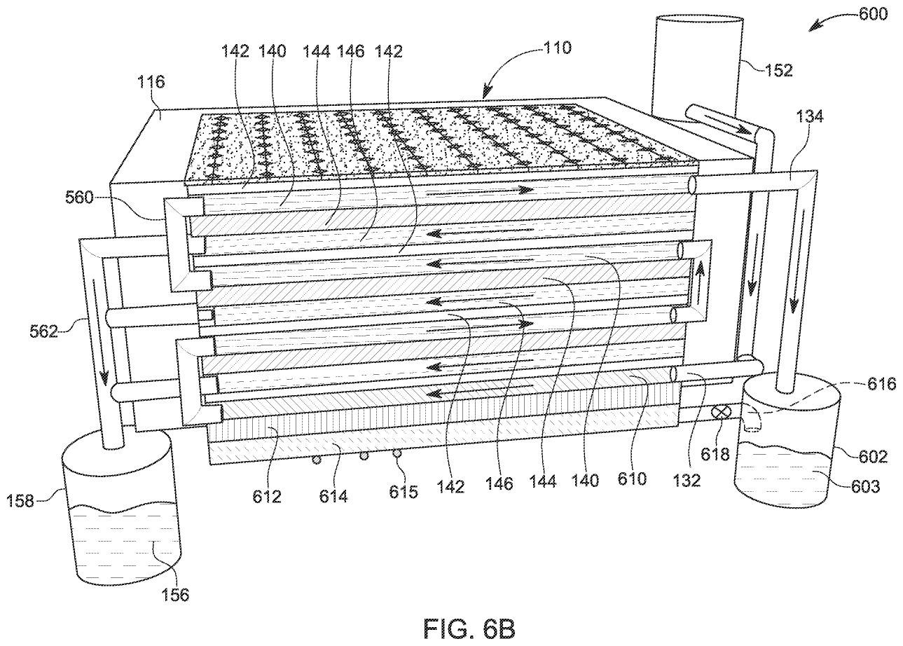

An overall view of a system 600, which is similar to system 500, is shown in FIG. 6A. Note that in this system, different from system 500, the contaminated water is provided first at the most bottom single-stage membrane distillation device 130, through input 132 and then, through the connecting pipes 560, the contaminated water is provided to the next single-stage membrane distillation devices 130, and the final contaminated water is exiting the top most single-stage membrane distillation device 130, at output 134 and then collected into a waste container 602. In addition, for this system 600, a contaminated water flow layer 610 was added to the bottom of the membrane distillation device 120 to heat the contaminated water before it enters the first evaporation layer 140, of the most bottom single-stage membrane distillation device 130, as shown in FIG. 6A.

A variation of the system 600 is shown in FIG. 6B, where an evaporative crystallizer layer 614 is placed at the bottom of the system 600, with an additional head conduction layer 612 separating the contaminated water flow layer 610 from the new evaporative crystallizer layer 614. The evaporative crystallizer layer 614 is fluidly connected with the waste container 602 through a conduit 616. The conduit 616 may be a pipe attached to a pump 618 for pumping the waste water 603 from the waste container 602 into the layer 614. Alternatively, the conduit 616 may be made of various fibers to promote capillarity move of the fluid from the waste container 602 into the layer 614.

The evaporative crystallizer layer 614 can be used as a cooler to lower the temperature of the bottom condensation layer 146. Water can be wicked by capillary effect or transported by pump to the evaporative crystallizer layer 614 and then evaporated to consume the heat recycled from the bottom condensation layer 146. The salt from the waste water 603 can be crystallized and then collected on the outside of the layer 614. For example, the crystalized salt 615, formed on the outside of the layer 614, can fall off the layer 614 driven by its own gravity, or the salt 615 can be taken together with layer 614 from system 600 and a new layer 614 is added. The water 603 used in this case can be the concentrated water produced from the system 600, as shown in FIG. 6B, or it may be seawater, brackish, industrial waste water, etc. In addition, once the concentrated water produced from the system 600 production rate is lower or equal to the evaporation rate of the evaporative crystallizer layer 614, zero liquid discharge can be achieved.

The evaporative crystallizer layer 614 may be made, in one embodiment, from a porous hydrophilic material, which may be nylon 6, nylon 66, cellulose products, Polyvinyl Alcohol, non-woven fabrics, silica fibers, glass fibers, polyvinyl acetate, etc.

In one embodiment, each stage of the membrane distillation device 120 includes four separate layers: a heat conduction layer 142, a hydrophilic porous layer as a water evaporation layer 140, a hydrophobic porous layer as a membrane distillation 144 for vapor permeation, and a water vapor condensation layer 146. In one implementation, an aluminum nitride (AlN) plate was used as the heat conduction layer 142 because of its extremely high thermal conductivity (>160 109 W·m⁻¹·K⁻¹) and its anti-corrosion property in salty water. The hydrophobic porous layer 144 was made in one embodiment of an electrospun porous polystyrene (PS) membrane. The water evaporation layer 140 and the water condensation layer 146 were made of the same material, a commercial hydrophilic quartz glass fibrous (QGF) membrane with non-woven fabric structure.

In each stage of the membrane distillation device 120, the heat is conducted through the thermal conduction layer 142 to the underlying hydrophilic porous layer 140. The source water 150 inside the hydrophilic porous layer 140 is then heated up to produce the water vapor 154. The water vapor 154 passes through the hydrophobic porous membrane layer 144 and ultimately condenses on the condensation layer 146 to produce the liquid clean water 156. The driving force for the water evaporation and vapor condensation is the vapor pressure difference caused by the temperature gradient between the evaporation and condensation layers.

In each stage 130, the latent heat of water vapor, which is released during the condensation process, is utilized as the heat source to drive water evaporation in the next stage 130. The multistage design 120 ensures the heat can be repeatedly re-used to drive multiple water evaporation-condensation cycles. In a traditional solar still, the heat generated from the sunlight via photothermal effect only drives one water evaporation-condensation cycle, which sets up an upper theoretical ceiling of the clean water production rate to about 1.60 kg·m²·h⁻¹, under one-Sun condition. The multistage design 120 makes possible to break this theoretical limit.

In the embodiments discussed herein, two contaminated water flow modes were presented, namely, the dead-end mode (FIGS. 1 to 4) and the cross-flow mode (FIGS. 5 and 6). In the dead-end mode, the source water may be passively wicked into the evaporation layer by hydrophilic quartz glass fibrous membrane strips via capillary effect. In this case, the concentration of salts and other non-volatile matters in the evaporation layer keeps increasing till reaching a saturation in the end. A washing operation is indispensable to remove the salts accumulated inside the system for this mode. However, the passive water flow reduces the complexity of the system and generates a high-water production rate in the early stage for this operation mode.

In the cross-flow mode shown in FIGS. 5 and 6, the source water flows into the system driven by gravity or by a mechanical pump, and it flows out of the system before reaching saturation. In this case, the outgoing water flow will take away a small amount of sensible heat, leading to a slight drop in clean water productivity in the early stage. However, this approach solves the salt accumulation problem and avoids the need for frequent cleaning and salt removal operations, which makes this configuration suitable for long-term operation.

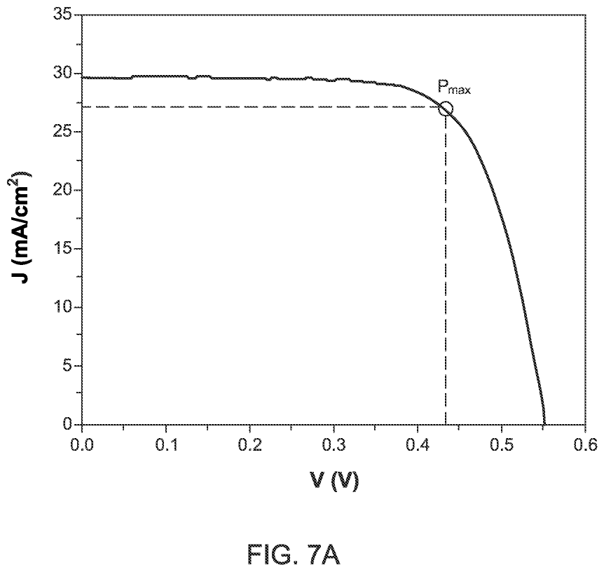

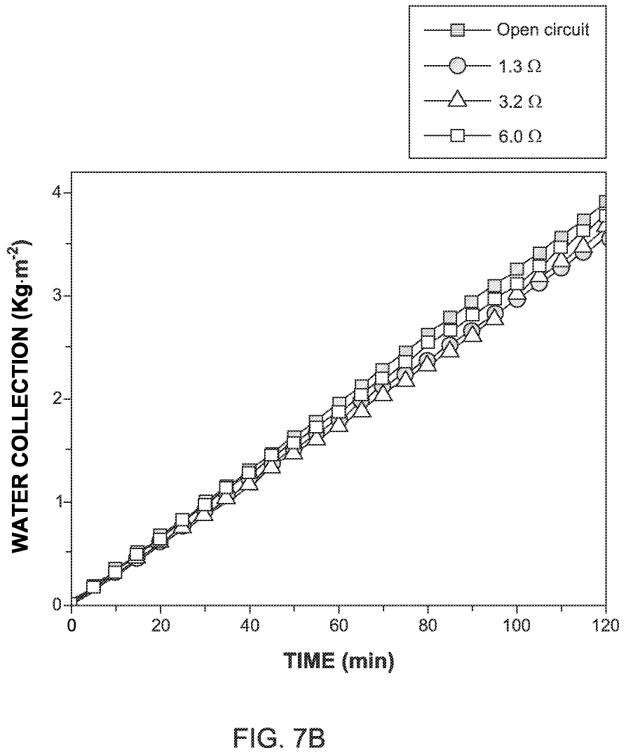

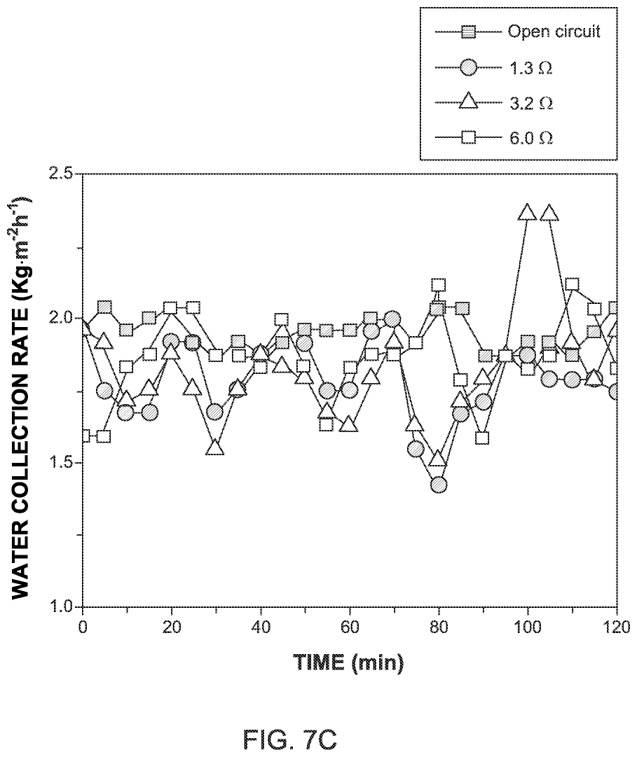

The water production performance of a 3-stage PV-MD system (i.e., a system that includes 3 single-stage membrane distillation devices 130) was investigated by connecting the solar PV panel to an external circuit with different resistances. When the system was working under one-Sun illumination with pure water as the source water, the temperature of the solar PV panel 110, which is slightly affected by the external resistance, was measured to be approximately 58° C. Because the performance of the solar PV panel is affected by its working state temperature, the J-V curve (which plots the generated current density versus voltage) of the panel 110 at the working state (58° C.) was measured under one-Sun illumination condition with simultaneous clean water and electricity production operation, as illustrated in FIG. 7A. Based on the J-V curve, the largest output power was determined to be 138 mW for this panel, which was achieved under an optimal load of 1.3Ω with a current of 0.32 A and an output voltage of 0.43 V. FIG. 7B shows the water production amount of the investigated system when the PV panel is connected to various loads. Although the effective working area of the tested PV-MD system (4.0 cm×4.0 cm) was 16 cm², the effective working area for the panel 110 was only 11.9 cm². The energy efficiency of this panel under this condition was calculated to be 11.6%.

When the panel 110 was connected to a resistance equal to its optimal load of 1.3Ω, the same PV-MD system exhibited a water production rate of 1.79 kg·m⁻²·h⁻¹ (see FIG. 7C), which is 8.7% lower than that without electricity output. When the resistance of the load was increased to 3.2 and 6.0Ω, the output power was decreased to 84 and 50 mW, respectively, with an increase of the output voltage to 0.52 and 0.53 V, respectively. The water production rates were 1.82 and 1.88 kg·m⁻²·h⁻¹ for these two cases, respectively, as seen in FIG. 7C. These results indicate that the water production rate is only slightly affected by the extraction of electricity from the system. Overall, the tested system gave a high clean water productivity (>1.79 kg·m⁻²·h⁻¹) given that about 11% solar energy was extracted from the PV-MD system to produce electricity in parallel with the fresh water generation.

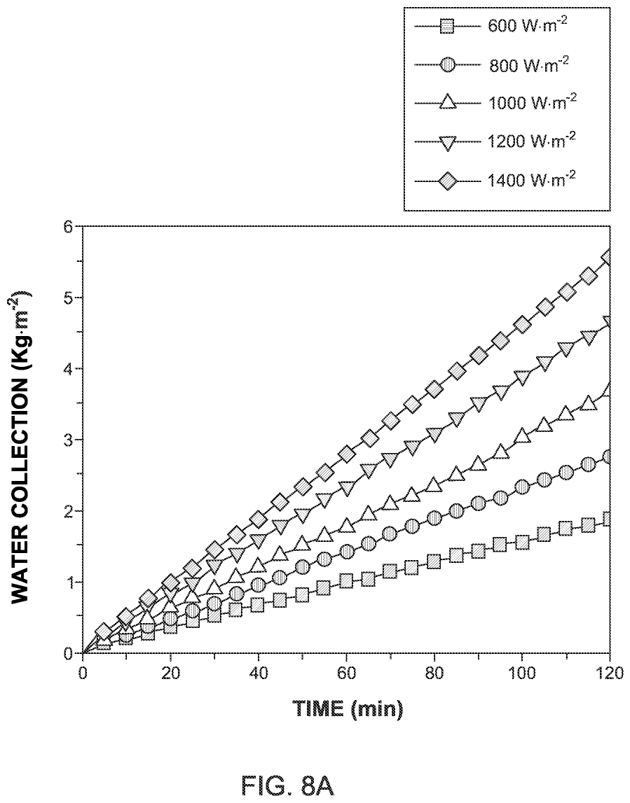

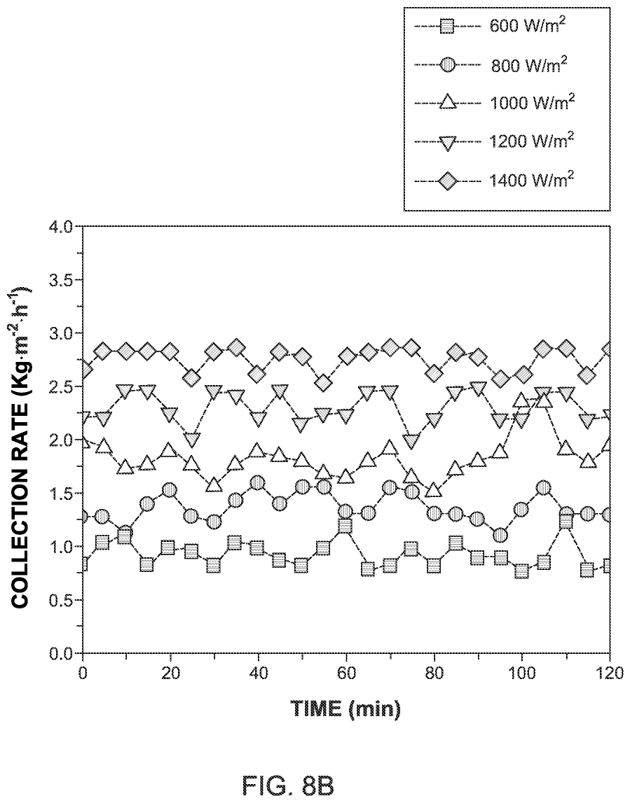

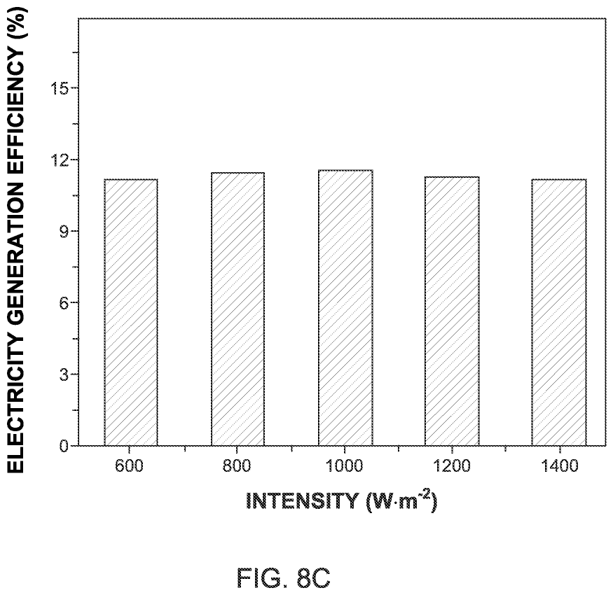

The clean water production performance of the 3-stage dead-end PV-MD system under solar illumination with different light intensity was also investigated and the results are presented in FIGS. 8A to 8C. The mass change rate of the collected water is shown in FIG. 8A and the average water production rates under 0.6, 0.8, 1.0, 1.2, and 1.4 Sun illumination were measured to be 0.92, 1.39, 1.82, 2.31 and 2.65 kg·m⁻²·h⁻¹, respectively, as shown in FIG. 8B. FIG. 8C shows the electricity generation efficiency under different solar irradiation intensities of the tested system. The relationship between the clean water production rate and solar irradiation intensity is linear and the electricity generation efficiency of the solar cell is stable, at about 11.1-11.6% under different solar irradiations. These results demonstrate that the PV-MD systems discussed herein possess very good clean water production and stable electricity generation performance under varying solar intensity.

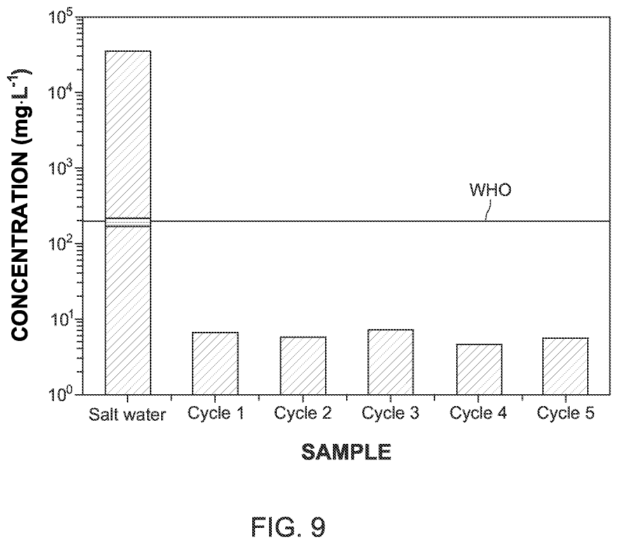

One targeted application of the PV-MD system is to generate electricity and at the same time produce clean water from various source waters with impaired quality, such as seawater, brackish water, contaminated surface water, and/or groundwater. When 3.5% NaCl aqueous solution was used as a seawater surrogate, the clean water production rate was 1.77 kg·m⁻²·h⁻¹ for an open circuit state and 1.71 kg·m⁻²·h⁻¹ for the optimal load state (1.3Ω). These two values are both lower than those recorded when pure water was used as the source water, which is attributed to the decrease of the saturation vapor pressure of the salt water. When the system 100 is operated in the dead-end mode, the salt concentration of the source water in the evaporation layer would gradually increase during operation, leading to a slight decrease in the clean water production rate. The concentrated source water inside the system 100 can be sucked out of by a dry paper via capillary effect. Although not all the NaCl salt was removed in this way, the performance of the system could be nearly fully recovered in the next operation cycle. In this regard, FIG. 9 shows the clean water production rate of the system 100 in the dead-end mode, measured over five operation cycles. In cycles 1, 3 and 5, the panel 110 was not connected to an external circuit, while in cycles 2 and 4, the panel 110 was connected to an external circuit. Note that curve WHO in FIG. 9 represents the World Health Organization's guidelines for drinking-water quality. The results of FIG. 9 indicate that the tested system can be regenerated from a salt accumulation state with fully recovered performance. The concentration of Na+ in the collected condensate water in each cycle was always lower than 7 ppm, which is only 0.02% of the source water, and much lower than the WHO drinking water standard.

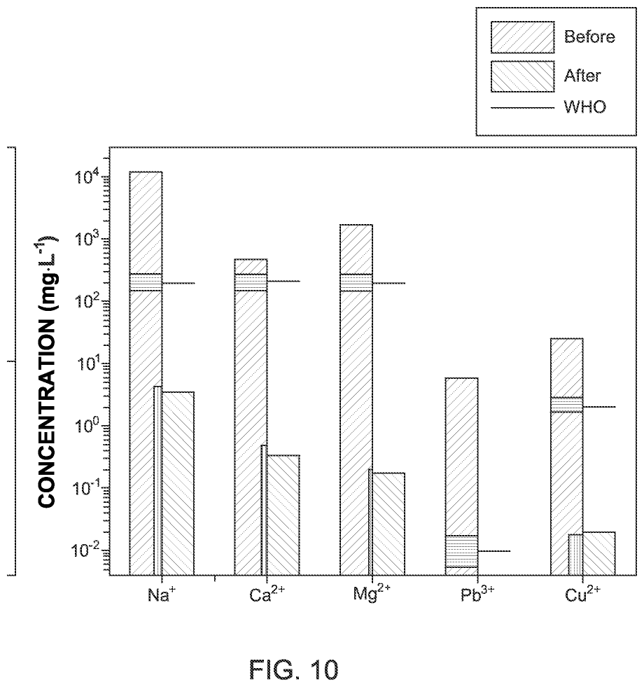

In another experiment, the PV-MD system 100 in the dead-end mode was used to produce clean water from a heavy metal-contaminated seawater. The PV-MD system exhibited a clean water production rate of 1.69 kg·m⁻²·h⁻¹ under one-Sun illumination. The concentrations of the ions in the contaminated water source and clean water product were measured and are shown in FIG. 10. For the collected clean water, the concentrations of Na+, Ca2+ and Mg2+ decreased to be lower than 4 ppm, while the concentrations of Pb3+ and Cu2+ decreased to almost zero and 0.02 ppm, respectively. All of the ion concentrations in the clean water obtained with the system 100 are below the WHO drinking water standards, as illustrated in the figure. These results convincingly indicate a perfect desalination performance via the membrane distillation process for the system 100.

In a PV-MD system operated in the dead-end mode, the salts from the source water will continuously accumulate inside the evaporation layer during operation, as mentioned above, which may cause failure and damage if salt crystals block the pores of the MD membrane. Although the salt can be cleaned out of the system by frequent regeneration operations, as previously discussed, it is not practical for long-term operation and large-scale application.

Therefore, the PV-MD system 500 or 600, which can be operated in a cross-flow mode, would solve the salt accumulation problem. For the system 600, a contaminated water flow layer 610 was added at the bottom of the membrane distillation device 120 to recycle the heat for the purpose of pre-heating the source water before entering into the first evaporation layer 140. When the water outlet 134 of the 3-stage cross-flow type PV-MD system 600 was blocked, i.e., it was operated in a dead-end mode with no water flowing out of the system, the clean water production rate was 2.09 kg·m⁻²·h⁻¹ with pure water as the source water, which is 7% higher than that recorded pure water on the dead-end type device under the otherwise same conditions (1.96 kg·m⁻²·h⁻¹). This result suggests that adding a contaminated water flow layer at the bottom of the system to recycle the heat can improve the clean water productivity.

When the water outlet 134 of the 3-stage cross-flow type PV-MD device was opened and the flow rate of the contaminated water was controlled to be 5 g·h⁻¹, which is about two times the water production rate in the dead-end mode, the clean water production rate was slightly decreased to 1.93 kg·m⁻²·h⁻¹. This observation can be explained by the fact that some sensible heat was carried away by the outgoing water flow at the outlet 134. When the flow rate of the contaminated water was increased to 6 and 7 g·h⁻¹, the clean water production rates were further decreased to 1.83 and 1.76 kg·m⁻²·h⁻¹, respectively. These results indicate that the clean water production rate was only slightly affected by the flow rate of the contaminated water because the outgoing water contains only a small amount of sensible heat.

The seawater desalination performance of the 3-stage PV-MD system 600 with the cross-flow mode was then evaluated. The flow rate of the contaminated water was controlled at 5 g·h⁻¹ to avoid continuous salt accumulation inside the system and the system exhibited a very stable clean water production rate of 1.65 kg·m⁻²·h⁻¹ under one-Sun illumination in a 3-day continuous test. In this case, a continuous concentrated contaminated water stream steadily flowed out of the system, keeping the salt concentration at a steady state inside the system. The salt concentration of the contaminated and concentrated seawater was 3.8 wt % and 8.7 wt %, respectively. Although the clean water production rate was slightly lower when the device was operated under these conditions, comparing to the dead-end mode, its long-term clean water production stability outweighs its slightly reduced rate.

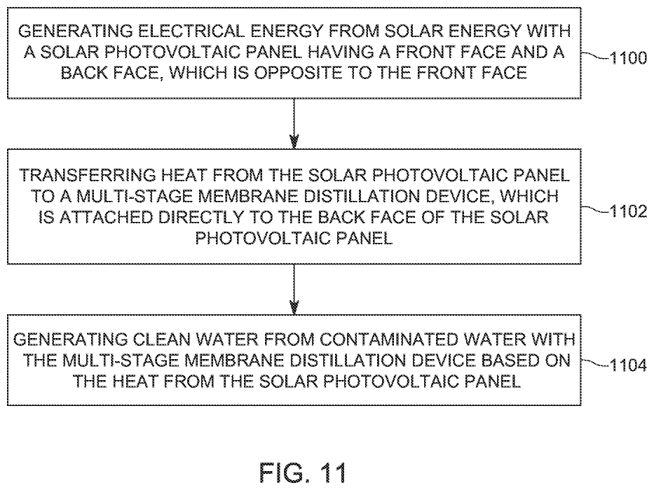

A method for simultaneously generating electrical energy and clean water with an integrated solar PV panel and a membrane distillation device is now discussed with regard to FIG. 11. The method includes a step 1100 of generating electrical energy from solar energy with a solar photovoltaic panel having a front face and a back face, which is opposite to the front face, a step 1102 of transferring heat from the solar photovoltaic panel to a multi-stage membrane distillation device, which is attached directly to the back face of the solar photovoltaic panel, and a step 1104 of generating clean water from contaminated water with the multi-stage membrane distillation device based on the heat from the solar photovoltaic panel.

In one application, the multi-stage membrane distillation device includes plural single-stage membrane distillation devices connected to each other, and each single-stage membrane distillation device includes a heat conduction layer, a water evaporation layer, a hydrophobic layer, and a condensation layer. The method may further include a step of heating the contaminated water with heat from the heat conduction layer, a step of evaporating the contaminated water in the water evaporation layer with the heat from the heat conduction layer, a step of allowing water vapor to pass the hydrophobic layer to the condensation layer, but not the contaminated water, and a step of condensing the water vapor into the clean water in the condensation layer.

In one application, each single-stage membrane distillation device has an input and no output fluidly connected to the water evaporation layer so that the contaminated water cannot pass through the water evaporation layer. In another application, each single-stage membrane distillation device has an input and an output fluidly connected to the water evaporation layer so that the contaminated water passes through the water evaporation layer.

The disclosed embodiments provide an integrated solar PV panel and a membrane distillation device that simultaneously generate electrical energy and uses the generated heat to clean contaminated water for producing clean water. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### REFERENCES

[1] Zhu, L., Gao, M., Peh, C. K. N., Wang, X. & Ho, G. W. Self-contained monolithic carbon sponges for solar-driven interfacial water evaporation distillation and electricity generation. Adv. Energy Mater. 8, 1702149 (2018).
[2] Yang, P. et al. Solar-driven simultaneous steam production and electricity generation from salinity. Energy Environ. Sci. 10, 1923-1927 (2017).
[3] Li, X. et al. Storage and recycling of interfacial solar steam enthalpy. Joule 2, 2477-2484 (2018).

1. An integrated solar PV panel-membrane distillation system comprising:
a solar photovoltaic panel having a front face for receiving solar energy and a back face, opposite to the front face; and
a membrane distillation device attached directly to the back face of the solar photovoltaic panel,
wherein the solar photovoltaic panel is configured to simultaneously generate electrical energy and transfer heat to the back membrane distillation device for generating fresh water from contaminated water.

2. The system of claim 1, wherein the membrane distillation device is a single-stage membrane distillation device or a multi-stage membrane device, which is composed by plural single-stage membrane distillation devices connected to each other.

3. The system of claim 2, wherein each single-stage membrane distillation device includes:
a heat conduction layer configured to transfer heat;
a water evaporation layer configured to evaporate the contaminated water to generate water vapor based on the heat received from the heat conduction layer;
a hydrophobic layer configured to allow the water vapor to pass through, but not the contaminated water; and
a condensation layer configured to condensate the water vapor into the fresh water.

4. The system of claim 3, wherein the heat conduction layer of a single-stage membrane distillation device of the plural single-stage membrane distillation devices is directly connected to the back face of the solar photovoltaic panel, or directly uses the back face of the solar photovoltaic panel as the heat conduction layer for this stage.

5. The system of claim 3, wherein the heat conduction layer, the water evaporation layer, the hydrophobic layer, and the condensation layer are arranged in this order.

6. The system of claim 3, wherein each of the water evaporation layer and the condensation layer includes a hydrophilic, porous, material.

7. The system of claim 6, wherein the hydrophilic, porous, material includes non-woven fabrics.

8. The system of claim 3, wherein the hydrophobic layer includes a hydrophobic, porous, material.

9. The system of claim 3, wherein the hydrophobic layer is empty.

10. The system of claim 3, wherein the condensation layer is empty.

11. The system of claim 3, wherein each of the water evaporation layer and the condensation layer is empty.

12. The system of claim 2, wherein each single-stage membrane distillation device has an input and no output fluidly connected to the water evaporation layer so that the contaminated water cannot exit the water evaporation layer.

13. The system of claim 2, wherein each single-stage membrane distillation device has an input and an output fluidly connected to the water evaporation layer so that the contaminated water enters at the input and exits at the output.

14. The system of claim 13, wherein each water evaporation layer of a single-stage membrane distillation device is fluidly connected to another water evaporation layer of another single-stage membrane distillation device.

15. The system of claim 1, further comprising:
a transparent cover configured to cover the front face of the solar photovoltaic panel and configured to make a chamber with the front face.

16. A method for simultaneously generating electrical energy and clean water, the method comprising:
generating electrical energy from solar energy with a solar photovoltaic panel having a front face and a back face, which is opposite to the front face;
transferring heat from the solar photovoltaic panel to a multi-stage membrane distillation device, which is attached directly to the back face of the solar photovoltaic panel; and
generating fresh water from contaminated water with the multi-stage membrane distillation device, based on the heat from the solar photovoltaic panel.

17. The method of claim 16, wherein the multi-stage membrane distillation device includes plural single-stage membrane distillation devices connected to each other, and each single-stage membrane distillation device includes a heat conduction layer, a water evaporation layer, a hydrophobic layer, and a condensation layer.

18. The method of claim 17, further comprising:
heating the contaminated water with heat from the heat conduction layer,
evaporating the contaminated water in the water evaporation layer with the heat from the heat conduction layer to generate water vapor;
forcing the water vapor to pass through the hydrophobic layer to the condensation layer, but not the contaminated water; and
condensing the water vapor into the fresh water in the condensation layer.

19. The method of claim 17, wherein each single-stage membrane distillation device has an input and no output fluidly connected to the water evaporation layer so that the contaminated water cannot exit the water evaporation layer.

20. An integrated solar PV panel-membrane distillation system comprising:
a solar photovoltaic panel having a front face for receiving solar energy and a back face, opposite to the front face;
a membrane distillation device attached directly to the back face of the solar photovoltaic panel; and
an evaporative crystallizer layer attached to the membrane distillation device, the evaporative crystallizer layer being configured to cool down a bottom layer of the membrane distillation device,
wherein the solar photovoltaic panel is configured to simultaneously generate electrical energy and transfer heat to the back membrane distillation device for generating fresh water from contaminated water.
